(19) United States
(12) Patent Application Publication
(10) Pub. No.: US 2026/0245334 A1
(43) Pub. Date: Aug. 20, 2026

(54) FRAME SEGMENTATION WITH MULTI-MODAL PROMPTS

(71) Applicant: QUALCOMM Incorporated, San Diego, CA (US)

(72) Inventors: Taotao JING, San Diego, CA (US); Shuai ZHANG, San Diego, CA (US); Eyasu Zemene MEQUANINT, San Diego, CA (US); Yingyong QI, San Diego, CA (US)

(21) Appl. No.: 19/054,698

(22) Filed: Feb. 14, 2025

(51) Int. Cl. G06V 10/26; G06F 40/40; G06V 10/25; G06V 10/77; G06V 10/82

(52) U.S. Cl. CPC G06V 10/267; G06F 40/40; G06V 10/25; G06V 10/7715; G06V 10/82

(57) ABSTRACT

The present disclosure provides techniques for frame segmentation. A method may include obtaining a first prompt associated with a first modality; obtaining a second prompt associated with a second modality that is different than the first modality; extracting a plurality of single-scale features from a frame; generating, by a neural network trained to perform mask segmentation based on a plurality of prompts, one or more masks for one or more target regions, in the frame, determined based on: the first prompt; the second prompt; and the plurality of single-scale features; and outputting, for display, the frame with at least one mask of the one or more masks.

### FIELD OF THE DISCLOSURE

Aspects of the present disclosure relate to techniques for frame segmentation.

### DESCRIPTION OF RELATED ART

Frame segmentation is a computer vision technique that is used to partition a frame into distinct regions or “segments.” The goal of frame segmentation is to simplify and represent a frame in a more understandable and analyzable manner, by separating different objects, areas, and/or structures within the frame, such as to enable computers to perceive and understand frame data in a manner that humans understand, view, and perceive. For example, with respect to a digital image, frame segmentation techniques may be used to divide the digital image into discrete groups of pixels, referred to as “segments.” Based on parsing the digital image’s complex visual data into specifically-shaped segments, image segmentation may help to enable faster, more advanced image processing.

Frame segmentation techniques may range from simple, intuitive heuristic analysis to the use of machine learning (ML). For example, some frame segmentation techniques identify boundaries of object(s) and classify object(s) captured in a frame by analyzing frame features, such as color, brightness, or intensity, for each sample (e.g., pixel, point, etc.) in the frame (e.g., image, point cloud, etc.) to identify boundaries of object(s) and/or classify object(s) depicted in the frame. Some other frame segmentation techniques may leverage ML model(s), such as deep learning models employing complex neural networks for sophisticated pattern recognition, to perform similar task(s). As used herein, deep learning is a subset of ML that uses multilayered neural networks (e.g., artificial neural networks (ANNs), deep neural networks (DNNs), and/or convolutional neural networks (CNNs)) to simulate the complex decision-making power of the human brain. For example, the neural networks may include multiple layers of interconnected nodes, each building on a previous layer to refine and optimize prediction of the network.

Frame segmentation has many applications in various fields, including, but not limited to, medical imaging, autonomous vehicles, robotics, agriculture, and gaming. For example, in medical imaging, frame segmentation may be used to identify and isolate organs, tissues, and/or lesions within medical images (e.g., such as magnetic resonance imagings (MRIs), ultrasounds, X-rays, and/or computed tomography (CT) scans) to enable healthcare professionals to analyze and quantify these areas for health monitoring, diagnosis, and/or treatment planning, among other tasks. As another example, in autonomous driving, frame segmentation may be used to enable a vehicle to navigate safely and efficiently on the road. Specifically, frame segmentation techniques may help the vehicle to accurately detect and avoid obstacles, identify and separate different lanes, and/or differentiate between different types of objects and areas in an environment surrounding the vehicle, including road(s), sidewalk(s), building(s), and/or vegetation. As another example, in robotics, frame segmentation may enable a robot to identify and separate different objects within a scene, such as to enable the robot to identify a specific object of interest and navigate towards that object, among other actions.

### SUMMARY

Certain aspects provide a method for frame segmentation, such as by an apparatus. The method may include obtaining a first prompt associated with a first modality; obtaining a second prompt associated with a second modality that is different than the first modality; extracting a plurality of single-scale features from a frame; generating, by a neural network trained to perform mask segmentation based on a plurality of prompts, one or more masks for one or more target regions, in the frame, determined based on: the first prompt; the second prompt; and the plurality of single-scale features; and outputting, for display, the frame with at least one mask of the one or more masks.

Other aspects provide a method for training a machine learning (ML) model to perform frame segmentation, such as by an apparatus. The method may include obtaining a plurality of training data instances, wherein each respective training data instance comprises: a respective training input comprising a respective frame and a respective first prompt associated with a first modality; and a respective training output comprising respective one or more ground truth masks for one or more respective first target regions in the respective frame; training the ML model comprising, for each training data instance of the plurality of training data instances: extracting a respective plurality of single-scale features from the respective frame associated with the respective training data instance; simulating a generation of a first respective second prompt associated with a second modality different than the first modality; generating, by the neural network, respective one or more first masks for one or more respective second target regions in the respective frame determined based on: the respective first prompt associated with the respective training data instance; the first respective second prompt; and the respective plurality of single-scale features; determining a respective loss value based on a loss function being configured to adjust the respective loss value based on a first comparison between the respective one or more first masks and the respective one or more ground truth masks associated with the respective training data instance; and modifying one or more parameters of the neural network based on the respective loss value.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for frame segmentation.

FIG. 2 depicts example benefits of using multiple prompts, having multiple modalities, (“multi-modal prompts”) for frame segmentation.

FIG. 3 depicts an example workflow for training a machine learning (ML) model to perform frame segmentation, such as based on multi-modal prompts.

FIG. 4 depicts an example artificial intelligence (AI) architecture.

FIG. 5 depicts an example artificial neural network (ANN).

FIG. 6 depicts an example method for frame segmentation.

FIG. 7 depicts an example method for training an ML model to perform frame segmentation, such as based on multi-model prompts.

FIG. 8 depicts aspects of an example apparatus.

### DETAILED DESCRIPTION

Aspects of the present disclosure provide apparatuses, methods, processing systems, and computer-readable mediums for frame segmentation based on multiple prompts, having multiple modalities (“multi-modal prompts”). For example, frame segmentation may be performed based on information included in a first prompt associated with a first modality and a second prompt associated with a second modality, where the first modality and the second modality are different. In certain aspects, the frame segmentation techniques described herein may be implemented by a system capable of being deployed on a mobile device, such as an edge device, to provide real-time and efficient frame segmentation, such as for various downstream applications (e.g., including those described in detail above).

As above, ML, particularly deep learning techniques, may be used for frame segmentation, allowing computers to precisely identify and delineate the boundaries of one or more target regions (e.g., associated with object(s), area(s), background(s), etc.) within an frame (e.g., such as at a sample level, for example, a pixel level, a point level, etc.). The one or more target regions may include countable (e.g., apple, car, etc.) and/or uncountable (e.g., sea, water, etc.) target regions.

One example ML solution for frame segmentation includes the Segment Anything Model (SAM) developed by Meta Artificial Intelligence (AI) (Meta AI®). SAM is a promptable, foundation model, specializing in image segmentation, allowing it to accurately locate one or more objects depicted within an image. As used herein, a “foundation model” may refer to a pre-trained deep neural network that forms the backbone for various downstream computer vision tasks, such as object detection, object classification, etc. SAM may be capable of generating segmentation masks (e.g., smaller images in larger images used to delineate the boundaries of segmented regions, such as to isolate and identify target regions within the larger image), for a wide variety of objects, and based on a variety of visual prompts (e.g., provided as input). This means that users can provide visual prompts to the model in various forms, such as via clicks, boxes, scribbles, or any other visual input indicating what to segment in an image. This versatility may allow users to specify the segmentation task according to their needs. Moreover, SAM may be capable of “zero-shot transfer,” meaning it has the ability to adapt to new image distributions and segmentation tasks without prior knowledge. In particular, SAM may rely on the knowledge it gains, after its millions of parameters are trained on massive datasets, to understand and segment a wide variety of images.

Despite the aforementioned benefits of SAM, SAM may fail to provide a segmentation interface that is capable of accommodating various types of user prompts, among other limitations. For example, SAM may focus on the use of visual prompts for the segmentation of images, and may be unable to simultaneously (e.g., at the same time) process a combination of different modalities (e.g., such as text input, visual input, etc.) as input for segmentation. The ability to handle multiple modalities may help to achieve more accurate identification and/or isolation of target regions (e.g., associated with various objects, areas, etc.) within an image.

Another example ML solution for frame segmentation, which overcomes the aforementioned limitation of SAM, includes the segment everything-everywhere model (SEEM) (e.g., also commonly referred to as the “segment everything-everywhere all at once model”). SEEM is a promptable and interactive segmentation system capable of segmenting everything (e.g., various semantics) everywhere (e.g., such as in multiple pixels that make up an image) all at once (e.g., based on simultaneously processing multiple prompts, often with multiple modalities). For example, SEEM may be capable of encoding various inputs into prompts in the same joint visual-semantic space such that the model is able to simultaneously handle any combination of input for frame segmentation. Specifically, an image encoder of SEEM may be designed to extract features from a frame, such as multi-scale features to represent information at different scales within the frame. Spatial queries (e.g., visual input), including points, boxes, scribbles, etc. may be encoded into visual prompts by pooling their corresponding visual features from the image encoder, while a text encoder may be used to covert text queries (e.g., textual input) into text prompts. SEEM may align the visual and text prompts in the joint visual-semantic space, such as to promote their synergy via cross-attention to achieve desired segmentation based on the various inputs. SEEM may thus be versatile to various combinations of prompts, while also being able to demonstrate strong segmentation performance on many segmentation tasks.

A technical problem of ML solutions used for frame segmentation, such as SEEM, however, includes their complex and heavy architecture. For example, while a powerful tool, SEEM may require significant processing power to run due to the complex calculations involved in (1) extracting detailed features (e.g., multi-scale features) from frames (e.g., such as via an image encoder) and (2) aligning visual and textual prompts such as to accurately partition a frame into distinct region(s) or segment(s), and further, generate segmentation mask(s), based on multi-modal prompts. In some cases, the multi-scale feature extraction used in SEEM may be considered computationally intensive because it involves performing multiple calculations on the same frame to extract multi-scale features, leading to a significant increase in processing time, power, and resources needed compared to single-scale feature extraction. The cross-attention layers in SEEM may need more computational resources to integrate and/or understand the multi-scale feature information, particularly for higher-resolution features. Furthermore, handling multi-scale features within the joint visual-semantic space (e.g., using knowledge fusion module(s)) may call for additional up-sampling and/or down-sampling operations to adjust the scale of attention masks (e.g., an “attention mask” is mechanism that may help a model decide which parts of the input it should pay attention to when generating an output) across different cross-attention layers. In this context, “up-sampling” and “down-sampling” may refer to a set of technique(s) used to change the spatial resolution of attention masks, such as to manipulate the level of attention a model pays to different parts of some input data. For example, “down-sampling” operations may be used to reduce the spatial resolution of an attention mask, while “up-sampling” operations may be used to increase the spatial resolution of an attention mask. These operations may result in the increase of computational costs and/or reduce efficiency.

Accordingly, existing ML solutions, such as SAM and SEEM, may not be effective for frame segmentation in some cases.

Certain aspects described herein overcome the aforementioned technical problems associated with existing frame segmentation solutions and provide a technical benefit to the field of computer vision. Specifically, certain aspects described herein provide an efficient system for frame segmentation that is capable of handling multi-modal prompts for the real-time segmentation of frames. For example, the system described herein may be used to generate one or more segmentation mask(s) for one or more target regions (e.g., such as target object(s)) in a frame based on at least two prompts, provided as input to the system. The prompts may include at least a first prompt associated with a first modality (e.g., such as textual input) and a second prompt associated with a second modality (e.g., such as visual input), which are provided as input to the system to specify which target region(s) within the frame are desired to be segmented by the system. For example, the system may offer a suite of convenient visual interfaces, such as on a mobile device, to enable a user to provide the multiple prompts for frame segmentation.

The system described herein may additionally include a lightweight and power efficient architecture used to process the frame and each of the multi-modality prompts for performing frame segmentation. For example, an image encoder, such as comprising only a small set of (convolutional) layers, may be used to extract single-scale features for the frame and represent them as vectors in a lower-dimensional space. The extracted features may provide semantic information about the frame, which may be analyzed by a neural network for performing frame segmentation. Specifically, the neural network may process the multi-modal prompts and the single-scale features to generate one or more segmentation mask(s) for the frame. The segmentation mask(s) generated by the system may include instance segmentation mask(s) and/or semantic segmentation mask(s) for one or more target region(s) in the frame. In certain aspects, memory of prior segmentation results may be used for multi-round interaction, such as to improve frame segmentation of the system.

Instance segmentation masks may be generated by the system to identify and segment individual target regions (e.g., individual objects) in an image, while semantic segmentation masks may be used to classify and segment similar target regions of an image. Specifically, unlike semantic segmentation, which classifies each sample (e.g., a pixel, a point, etc.) of a frame into broad categories without distinguishing between different instances of the same class, instance segmentation may provide a more granular understanding by differentiating between individual target regions (e.g., individual objects) and assigning a unique label to each object instance.

The lightweight architecture of the system described herein may be attributable to (1) the lightweight image backbone of the system and (2) the use of single-scale features (as opposed to multi-scale features), which, in turn, helps to reduce the number of cross-attention and self-attention layers used for cross-modal knowledge fusion to generate one or more segmentation mask(s) for the frame based on the multi-modal prompts. Different from SEEM, using lower resolution single-scale image features may help to reduce the computational cost of (1) the across-attention calculations and (2) the repeated up-sampling and down-sampling operations (e.g., performed for cross-modal knowledge fusion), as the performance of such operations may be reduced and/or may not be needed any more.

The system and techniques for frame segmentation described herein may provide various beneficial technical effects and/or advantages. For example, the system and techniques for frame segmentation may enable improved segmentation accuracy and efficiency. The improved segmentation accuracy may be attributable to the ability of the system to analyze multi-modal prompts when partitioning a fame into distinct regions or segments. For example, the system may have a more comprehensive understanding of the target region(s) that are desired to be segmented in a frame based on considering information and/or cues from different prompts, such that more accurate frame segmentation is achieved. More accurate frame segmentation may help to improve downstream applications, which rely on this segmentation for performing various tasks. The improved segmentation efficiency may be attributable to the use of a light-weight and power efficient image encoder and/or neural network for performing the frame segmentation. In certain aspects, this lightweight and power-efficient design may enable the system to be deployed on a mobile devices, such as an edge device, for real-time frame segmentation.

### Example System for Frame Segmentation

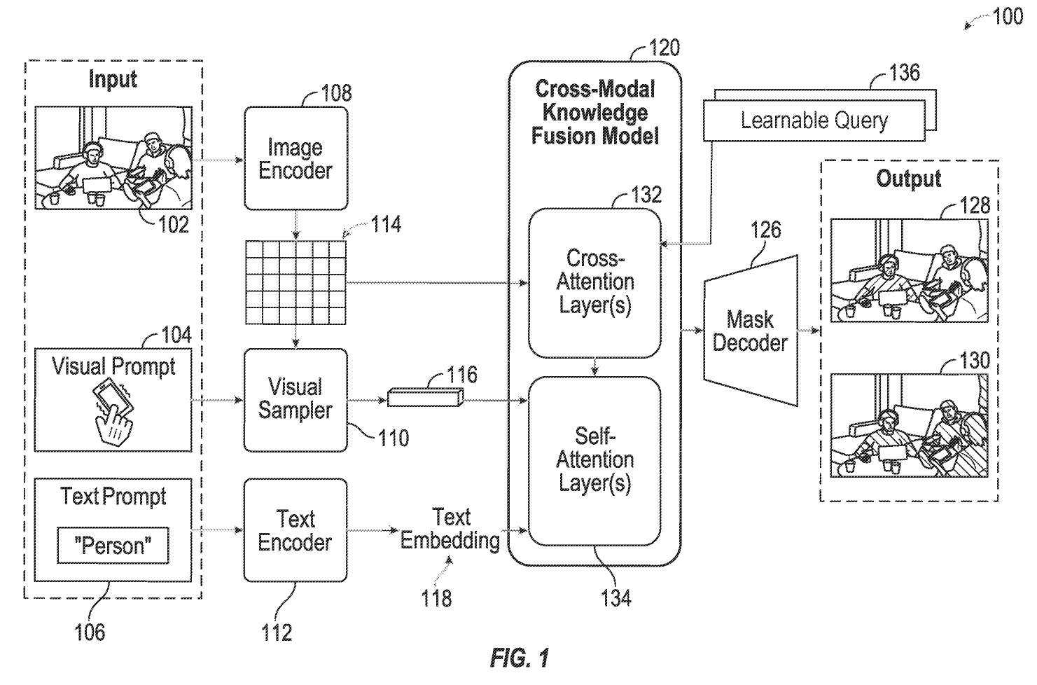

FIG. 1 depicts an example system 100 configured to perform frame segmentation, such as based on multiple prompts, having different modalities. For example, system 100 may be used to generate one or more segmentation masks for one or more target regions in a frame based on at least two prompts, provided as input to the system 100. The segmentation mask(s) generated by system 100 may include instance segmentation mask(s) and/or semantic segmentation mask(s) for the target region(s) in the frame.

For example, as shown in FIG. 1, system 100 includes an image encoder 108, a visual sampler 110, a text encoder 112, a cross-modal knowledge fusion model 120, and a mask decoder 126, which may be used to perform frame segmentation for a frame 102.

Frame 102 may capture one or more objects in a scene, such as a dynamic real-world scene (e.g., a scanned environment), for a first time period (e.g., time T = 0). For example, the frame 102 may include depictions of object(s) in the scene during the first time period. In certain aspects, frame 102 may comprise a two-dimensional (2D) frame or 2D representation, such as a 2D image (simply referred to herein as an “image”). For example, an image sensor, such as a camera, may be used to produce the image of the frame 102. The image of the frame 102 may include samples, such as pixels, in 2D space for a scanned environment. At least a subset of the pixels may be associated with one or more objects in the scanned environment. In certain other aspects, frame 102 may comprise a three-dimensional (3D) frame or a 3D representation, such as a 3D point cloud (simply referred to herein as “a point cloud”). For example, a 3D sensor, such as a light detection and ranging (LiDAR) sensor, may be used to produce the point cloud of the frame 102. The point cloud of the frame 102 may include a collection of samples, such as points, in 3D space for the scene. At least a subset of the points may be associated with one or more objects in the scanned environment.

In the example shown in FIG. 1, frame 102 is an image captured by an image sensor. The frame 102 may include depictions of at least three individuals in a living room during a first time period. The frame 102 may also include depictions of a laptop, a basketball, game consoles, cups, a table, and a couch that are also in the living room during the first time period. The frame 102 may have been captured by an image sensor in the living room during the first time period. Although aspects herein are described with respect to the frame 102 comprising an image, in certain other aspects, other frame data (e.g., such as point cloud data) may be considered for frame segmentation.

System 100 may begin performing frame segmentation based on obtaining a visual prompt 104 and a text prompt 106, in addition to frame 102. Visual prompt 104 and text prompt 106 may be provided via one or more interfaces of systems 100. For example, visual prompt 104 may be visual input, such as a click, a bounding box, a scribble, or any other visual input, associated with frame 102 indicating what to segment in frame 102. In certain aspects, visual prompt 104 may be provided by a user. For example, visual prompt 104 may be provided by a user as annotations in frame 102 to highlight specific area(s) of interest, referred to herein as “target region(s),” within frame 102, which the user intends system 100 to segment within frame 102.

Text prompt 106, on the other hand, may include a specific word or multiple word (e.g., phrase or sentence) input provided to system 100 to instruct system 100 to segment frame 102, and thus generate one or more segmentation masks. In certain aspects, text prompt 106 may be typed directly into an interface provided by system 100, such as within a text box provided to a user of system 100. In certain aspects, text prompt 106 may be spoken into a microphone and translated into text by system 100. In certain aspects, text prompt 106 may be provided to system 100 such as through a programming interface. Similar to visual prompt 104, in certain aspects, text prompt 106 may be provided as input to system 100 by a user of system 100. In certain aspects, text prompt 106 may include a class name of a target region (e.g., target object) that is desired to be segmented and/or attribute(s) describing the target region (e.g., target object).

In the example shown in FIG. 1, visual prompt 104 includes a user-provided click within frame 102. For example, a user may click on the person in frame 102 having headphones on and looking at his laptop, to indicate that that this specific person is to be segmented in frame 102 (e.g., instance segmentation) and/or that all persons in frame 102 are to be segmented (e.g., semantic segmentation). Further, textual prompt 106, in this example, includes user-provided text of “person.” A user may provide “person” text to indicate that a single instance of a person in frame 102 is to be segmented in frame 102 (e.g., instance segmentation) and/or that all person in frame 102 are to be segmented (e.g., semantic segmentation). Although not meant to be limiting to this particular example, here, the user may intend for system 100 to generate both semantic segmentation masks and an instance segmentation mask in frame 102. For example, the user may desire that system 100 outputs, for display, frame 102 with an instance segmentation mask used to isolate and specifically cover the person in frame 102 having headphones and facing his laptop. Further, the user may desire that system 100 outputs, for display, frame 102 with semantic segmentation masks used to isolate and cover multiple persons (e.g., at least the three persons) in frame 102.

To perform such frame segmentation, image encoder 108, of system 100, may be used to extract features 114 from frame 101. For example, image encoder 108 may be used to transform frame 102 into image features 114, or essentially “image embeddings,” which are numerical representations of frame 102 encoded into a lower-dimensional vector representation. In other words, image feature extraction performed by the image encoder 108 may be used to extract distinct features 114 in frame 102 and represent them as vectors in a lower-dimensional space. The extracted features 114 may provide semantic information about frame 102 by capturing low-level visual features, such as edges, and textures, and/or higher-level semantic information, such as objects, in frame 102. The extracted features 114 may include meaningful features from frame 102, thereby allowing models, such as cross-modal knowledge fusion model 120 described in detail below, to interpret the content of frame 102 more easily.

According to aspects described herein, image encoder 108 may be used to extract single-scale features 114, as opposed to multi-scale features, from frame 102. A "single-scale feature 114" extracted by image encoder 108 may refer to a feature 114 extracted from frame 102 at a single resolution level, meaning image encoder 108 may process frame 102 at one scale without applying any additional down-sampling and/or up-sampling to capture information at other resolutions/sizes. This is different than multi-scale feature extraction where frame 102 may be analyzed at multiple scales to extract features from frame 102 for varying sizes/resolutions of frame 102. For example, one scale feature 114 (64 x 64) may be extracted by image encoder 108. In certain aspects, to perform single-scale feature extraction, image encoder 108 may comprise a CNN-based architecture (e.g., more efficient than attention-based networks, such as vision transformers (ViTs)) with a small set of convolutional layers. In certain aspects, image encoder 108 may be a light-weight convolution encoder, such as FastViT, which is a fast hybrid vision transformer that uses structural reparameterization.

Visual sampler 110, of system 100, may be used to select a subset of the extracted features 114, generated for frame 102 by image encoder 108, based on visual prompt 104. For example, features 114 associated with an area of frame 102 clicked on, circled, boxed, and/or indicated via some other visual input included in visual prompt 104 may be selected by visual sampler 110 and provided as separate input 116 to cross-modal knowledge fusion model 120 for frame segmentation of frame 102.

Text encoder 112, of system 100, may be used to generate a text embedding 118 for text prompt 106, which a machine or ML model, such as cross-modal knowledge fusion model 120, may understand. “Text embedding 118” may refer to a vector representation of a piece of text (e.g., such as a word, a phrase, a sentence, etc.) used to capture its meaning and context. A text embedding 118 may map such text into a vector space, where other pieces of text are represented as vectors. Similar pieces of text may have similar text embeddings and thus may be positioned close together in the vector space, meaning their numerical representations are alike.

In certain aspects, text encoder 112 is a language model (LM), designed to understand and process input text, such as to generate text embeddings, including text embedding 118. In certain aspects, text encoder 112 is a large language model (LLM), such as LLaMA developed by Meta AI®. In certain aspects, text encoder 112 is a deep learning multimodal model, such as contrastive language-image pre-training (CLIP) developed by OpenAI®, which combines knowledge of English-language concepts with semantic knowledge of images.

In certain aspects, text encoder 112 is trained to generate text embeddings for input text, such as text embedding 118 for text prompt 106. Training text encoder 112 may include exposing text encoder 112 to vast amounts of text, thereby allowing text encoder 112 to (1) learn the complex patterns of language usage and meaning, and (2) learn how to represent text as numerical vectors (e.g., text embeddings), which capture such usage and meaning of the text. In certain aspects, training text encoder 112 on the large corpus of text enables text encoder 112 to produce text embeddings for input text (e.g., such as a text prompt 106) that it has previously seen during training. For example, if the training data used to train text encoder 112 included a ground truth text embedding for text input “traffic light,” then text encoder 112 may be capable of producing the text embedding for “traffic light,” should this text input be provided as input (e.g., as text prompt 106) to system 100. In certain aspects, training text encoder 112 on the large corpus of text may further enable text encoder 112 to produce embeddings for input text (e.g., such as text prompt 106) that it has not previously seen during training. For example, if the training data used to train text encoder 112 included a ground truth text embedding for text input “traffic light” but not for text input “light source,” then text encoder 112 may still be capable of producing the text embedding for “light source,” should this text input be provided as input (e.g., as text prompt 106) to system 100. In other words, text encoder 112 may have “open-vocabulary capabilities,” allowing the encoder to handle and generate text embeddings for a wide range of text input, such as beyond its initial training set. For example, based on its learned understanding of language patterns and relationships between different words, phrase, and/or sentences, text encoder 112 may be able to produce text embeddings for text input that it has not previously been trained on. As such, text encoder 112 may allow for greater flexibility in the segmentation of frame 102, such as based on multiple text input variations.

Cross-modal knowledge fusion model 120 and mask decoder 126 (e.g., together forming a “neural network”) may process (1) single-scale features 114 generated by image encoder 108, (2) input 116 (e.g., a subset of the single-scale features 114) from visual sampler 110, and (3) text embedding 118 from text encoder 112 to identify one or more target regions in frame 102 to isolate, and further mask (e.g., generate one or more masks used to cover the one or more target regions in frame 102). In certain aspects, cross-modal knowledge fusion model 120 and mask decoder 126 may utilize learnable queries 136 to (1) understand the input frame 102 (e.g., represented as single-scale features 114) and the input prompts, specifically visual prompt 104 and text prompt 106 (e.g., represented as input 116 and text embedding 118), and further, (2) predict the final segmentation output. Learnable queries 136 may comprise trainable vectors (e.g., trainable parameters) that allow cross-modal knowledge fusion model 120 and mask decoder 126 to dynamically focus on relevant parts of some input, whether it’s within a same sequence (e.g., self-attention) or across multiple sequences (e.g. cross-attention) (e.g., a “sequence” may refer to a collection of elements, such as tokens, processed together by a model).

For example, one or more cross-attention layers 132 of cross-modal knowledge fusion model 120 may process single-scale features 114 (e.g., as input) and output updated learnable queries 136 with integrated input frame 102 knowledge. Specifically, “cross-attention” may occur between the input frame 102 (e.g., represented as single-scale features 114) and learnable queries 136. Further, one or more self-attention layers 134 of cross-modal knowledge fusion model 120 may process input 116 from visual sampler 110 and text embedding 118 from text encoder 112 (e.g., as input) and output further updated learnable queries 136 with integrated prompt information knowledge. Specifically, “self-attention” may occur between the learnable queries 136 and the input prompts (e.g., input 116 associated with the visual prompt 104 and text embedding 118 associated with the text prompt 106). After learning and understanding input frame 102 and the input prompts information, the updated learnable queries 136 may be provided as input to mask decoder 126. Mask decoder 126 may use the learnable queries 136 to delineate target region(s) in frame 102 that are desired to be segmented in frame 102 and further generate mask(s) for these target region(s) in frame 102. More specifically, mask decoder 126 may be designed to generate mask(s) for frame 102, used to outline or cover desired target region(s) (e.g., object(s), area(s), etc.) in frame 102 based on visual prompt 104 and text prompt 106.

In certain aspects, mask decoder 126 generates only semantic segmentation mask(s) for frame 102. In certain aspects, mask decoder 126 generates only instance segmentation mask(s) for frame 102. In certain aspects, mask decoder 126 generates both semantic segmentation mask(s) and instance segmentation mask(s) for frame 102. For example, in the example shown in FIG. 1, mask decoder 126 may output, for display, (1) a first instance 128 of frame 102 with an instance segmentation mask associated with only the person in frame 102 having headphones on and looking at his laptop and (2) a second instance 130 of frame 102 with semantic segmentation masks associated with all “persons” in frame 102. Each of the instance segmentation mask and the semantic segmentation masks may be generated based on processing visual prompt 104, e.g., the user-provided click on the person having headphones and looking at his laptop, and the text prompt 106, e.g., the text “person.” In certain aspects, the neural network (e.g., including mask decoder 126) may be capable of producing both instance segmentation mask(s) and semantic segmentation mask(s) based on the neural network having two different segmentation heads for instance and semantic level masks predictions. The different segmentation heads may be trained using different ground-truth annotations, and thus, may be used to produce different output.

In certain aspects, the neural network (e.g., cross-modal knowledge fusion model 120 and mask decoder 126) may additionally generate a confidence score for each mask generated by mask decoder 126. A confidence score generated by the neural network, and associated with a generated mask, may indicate the neural network’s level of certainty about the accuracy of the generated mask. For example, a higher confidence score may indicate a greater likelihood that the associated mask accurately segments a target region that is desired to be segmented, while a lower confidence score may indicate the opposite. In certain aspects, only those masks with associated confidence scores above a threshold confidence score may be generated for display and thus displayed to a user.

The predicted segmentation mask(s) may be used for multiple real-life applications. One example application includes image editing, where the image segmentation mask(s) are leveraged to help change the color and/or light condition of a specific object, auto-focus and/or re-focus an image, remove one or more distractions in the background of an image, and/or the like.

Although system 100 depicted in the example in FIG. 1 may be used to perform frame segmentation based on multi-modal prompts, in some other cases, system 100 may be capable of performing frame segmentation based on a single text prompt or a single visual prompt, and/or for various different prompts and/or frames.

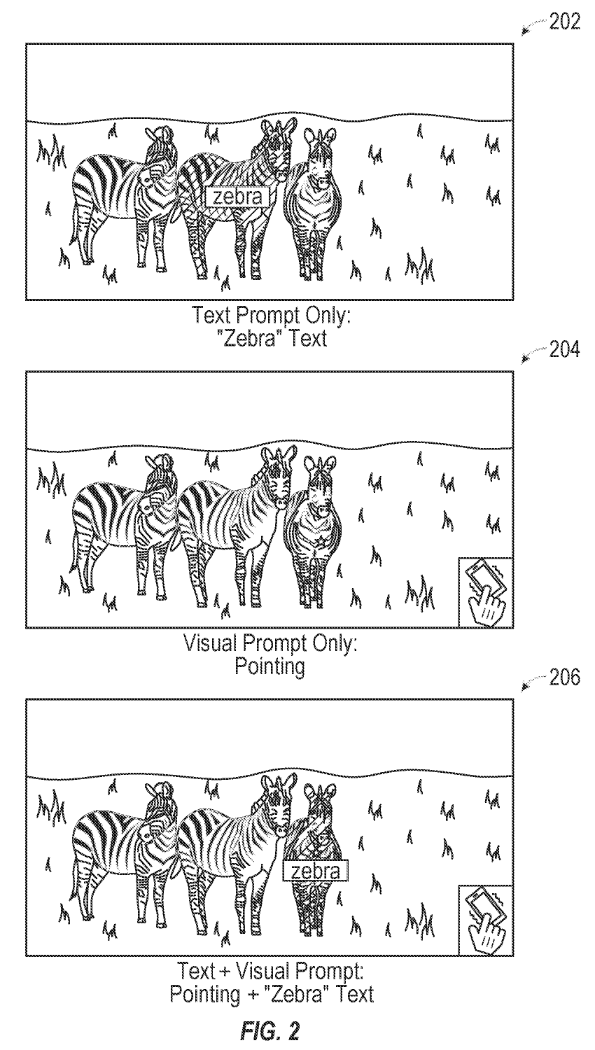

The aforementioned techniques implemented by system 100 for processing multi-modal prompts (e.g., a visual prompt 104 and a text prompt 106 simultaneously) to perform frame segmentation may provide various beneficial technical effects and/or advantages, including, but not limited to, improved frame segmentation accuracy. For example, by analyzing multiple prompts, having different modalities, system 100 may better understand what is desired to be segmented in frame 102 and thus carry out the frame segmentation accordingly. This improved segmentation accuracy, realized when using the techniques describe herein, is depicted in the example provided in FIG. 2.

For example, in FIG. 2, frame segmentation may be carried out at 202,204, and 206 for a same frame. The frame may comprise a 2D image captured by an image sensor. The frame may include depictions of at least three zebras in a field during a first time period. Frame segmentation carried out at 202 may be carried out by a system, such as system 100, based on only a text prompt (e.g., an example of text prompt 106 in FIG. 1) of “Zebra.” Frame segmentation carried out at 204 may be carried out by a system, such as system 100, based on only a visual prompt (e.g., an example of visual prompt 104 in FIG. 1) of a user-provided click on a portion of the third zebra, depicted in the frame on the right. Frame segmentation carried out at 206 may be carried out by a system, such as system 100, based on both a text prompt of “Zebra” and a visual prompt of a user-provided click on a portion of the third zebra depicted in the frame on the right. For each frame segmentation example, the user may intend that the system generate only a segmentation mask for the zebra depicted in the right of the frame, such as based on providing the various prompt(s). However, as shown in FIG. 2, only frame segmentation performed at 206 may result in the accurate frame segmentation desired by the user.

For example, frame segmentation carried out at 202 based on the text prompt only may result in the generation of a mask for the middle zebra in the frame. Specifically, based on providing “Zebra” text, the system may determine that only one zebra is to be segmented and randomly select the middle zebra. The middle zebra may not be the zebra that is intended to be segmented in the frame.

Frame segmentation carried out at 204 based on the visual prompt may result in the generation of a mask for only a single stripe on the third zebra, from the left, in the frame. Specifically, based on providing the user-provided click in the frame, the system may struggle to determine if the user intended for the whole zebra to be segmented or only a single stripe of the zebra. The single stripe on the third zebra in the frame may not represent the correct segmentation intended for the frame.

Frame segmentation carried out at 206 based on both the text prompt and the visual prompt, however, may result in the generation of a mask for the third zebra, from the left, in the frame. This is the segmentation that may have been originally intended by the user when providing the text prompt and the visual prompt. Thus, as shown in FIG. 2, processing multiple prompts for frame segmentation may help to clear up any ambiguities, such as to achieve more accurate frame segmentation.

### Aspects Related to Training an ML Model for Frame Segmentation

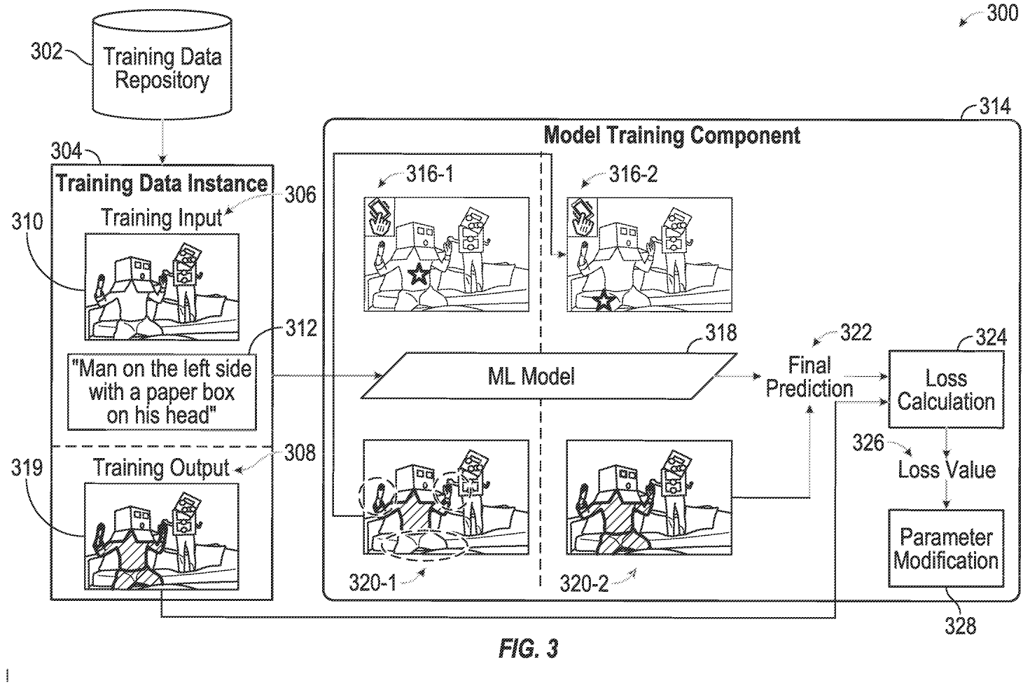

FIG. 3 depicts an example workflow 300 for training an ML model 318 to perform frame segmentation, such as based on multi-modal prompts. For example, in certain aspects, the ML model 318 may comprise a neural network (e.g., cross-modal knowledge fusion model 120 and mask decoder 126) such as in FIG. 1, such that workflow 300 is used to train the neural network in FIG. 1 to perform frame segmentation based on multiple user-provided prompts. The user-provided prompts may include at least a first prompt associated with a first modality and a second prompt associated with a second modality, such as visual prompt 104 and text prompt 106 in FIG. 1.

In certain aspects, workflow 300 may implement simulation techniques to simulate the generation of user-provided prompts that may be provided to a system, such as system 100 in FIG. 1, for multi-modal prompt-based frame segmentation. For example, as shown in FIG. 3, simulation techniques may be used to simulate example visual prompts 316-1 and 316-2 (individually referred to herein as “visual prompt 316” and collectively referred to herein as “visual prompts 316”) that may be provided as input by a user, such that the system learns how to handle these types of prompts, in combination with a textual prompt 312, for performing frame segmentation. Although workflow 300 depicts the simulation of visual prompts, in some other examples, workflow 300 may implement simulation techniques to simulate the generation of other types of prompts, such as various text prompts, that may be provided to the system for performing multi-modal prompt-based frame segmentation.

Prior to beginning workflow 300, parameters for the ML model 318 may be initialized. Further, prior to beginning workflow 300, a plurality of training data instances may be obtained, such as from a training data repository 302. Each training data instance may include a training input and a training output. The training input associated with a training data instance may include a respective frame (e.g., depicting a scene during a time period) and a respective text prompt. The training output associated with the training data instance may include respective one or more ground truth masks for one or more respective first target regions in the respective frame.

Workflow 300 begins with selecting one of the training data instances. In this example, the training data instance 304 including training input 306 and training output 308 may be selected. Training input 306 may include a frame 310 and an example text prompt 312. The frame 310 may be a 2D image, such as captured by an image sensor. The frame 310 may depict a man and a child, each with a box on their heads, situated on a couch in a living room (e.g., during a first time period). The textual prompt 312 may include text “man on the left side with a paper box on his head.” Textual prompt 312 may be used to prompt the system to generate an instance segmentation mask for the man depicted in the left side of frame 310, without also masking the box on his head. Training output 308 may include an instance 319 of frame 310 having a mask outlining the man depicted in the left side of frame 310, without the box on his head.

Workflow 300 then proceeds with a model training component 314 training the ML model 318 based on the selected training data instance 304. For example, in a first iteration of the training based on the selected training data instance 304, model training component 314 may simulate a generation of a first visual prompt 316-1. As shown in FIG. 3, the first visual prompt 316-1 may be a user-simulated click within frame 310, such as on a stomach of the man in the left side of the frame. Further, model training component 314 may (1) extract single-scale features from frame 310, (2) obtain a subset of the single-scale features based on the simulated visual prompt 316-1, and (3) generate a text embedding for textual prompt 312 (not shown in FIG. 3). Model training component 314 may train ML model 318 to generate a first mask prediction 320-1 based on (1) the single-scale features, (2) the subset of single-scale features associated with simulated visual prompt 316-1, and (3) the text embedding. In this example, the first mask prediction 320-1 may include frame 310 with a single mask outlining the shirt of the man in frame 310. Thus, the first mask prediction 320-1 may be a prediction by the ML model 318 that is partially correct, given it accurately segments the shirt of the man but does not also segment his legs and hands in frame 310.

To improve the prediction by ML model 318, another iteration may be performed for the same training data instance 304. For example, in the second iteration of the training based on the selected training data instance 304, model training component 314 may simulate a generation of a second visual prompt 316-2. As shown in FIG. 3, the second visual prompt 316-2 may be a click within frame 310 on a leg of the man in the left side of the frame. Model training component 314 may obtain another subset of the single-scale features based on the simulated visual prompt 316-2 and additionally use this subset and/or the first mask prediction 320-1 (along with the single-scale features, the first subset of the single-scale features, and/or the text embedding from the first iteration) to generate a second mask prediction 320-2. In this example, the second mask prediction 320-2 may include frame 310 with a single mask outlining the shirt of the man in frame 310, along with his hands and legs, and without the box on his head. ML model 318 may use second mask prediction 320-2 as its final prediction 322.

Workflow 300 then proceeds with model training component performing loss calculation 324 to determine a loss value 326. The loss value 326 may be determined based on final prediction 322 and training output 308. For example, final prediction 322 may be compared with instance 319 of frame 310, having a mask outlining the man depicted in the left side of frame 310, without the box on his head, associated with training data instance 304, such as to evaluate the similarity of the predicted segmentation mask(s) (e.g., included in final prediction 322) with the ground truth mask(s) associated with training data instance 304.

In certain aspects, evaluating the similarity of the predicted segmentation mask(s) with the ground truth mask(s) associated with training data instance 304 is performed using a loss function. The loss function is a mathematical function that measures how well the ML model 318 is able to predict the desired output, and more specifically, generate the intended mask(s) for frame 310, based on multi-modal prompts. A loss value determined using the loss function may be minimized (or equal to zero) when the predicted segmentation mask(s) match (or are nearly similar to) the ground truth mask(s) associated with training data instance 304. In certain aspects, the loss function is a binary cross-entropy loss function. In certain aspects, the loss function is a DICE loss function that is based on a DICE similarity coefficient, which is a measure of similarity between two sets of data.

In certain aspects, model 318 may generate a confidence score for each predicted mask, such as a first confidence score for first mask prediction 320-1 and a second confidence score for second mask prediction 320-2. In certain aspects, the number of predicted masks and corresponding confidence scores may be equal to the number of learnable queries used by model 318, such as learnable queries 136 depicted and described above with respect to FIG. 1. The generated confidence scores may be used to determine the mask prediction 320 with the highest confidence score, such that this mask prediction and confidence score may be used to calculate the loss value 326 (e.g., during loss calculation 324). In certain aspects, the other mask predictions 320 associated with lower confidence scores may not be used to determine loss value 326 and further update the network (e.g., perform parameter modification 328). In certain aspects, such as during a test stage, the confidence scores generated by model 318 for mask predictions 320 may be used to rank the mask predictions 320 and return only the mask prediction 320 associated with a highest confidence score as final prediction 322.

In certain aspects, loss value 326 may be used to modify various parameter(s) of ML model 318 during parameter modification 328.

In certain aspects, modifying parameter(s) of the ML model 318 may be performed until all training data instances (e.g., such as included in training data repository 302) have been used to train the ML model 318. In certain aspects, modifying parameter(s) of the ML model 318 may be performed until a training termination condition is reached. One example of a training termination condition includes convergence (e.g., further training may not lead to any significant loss reduction). Another example of a training termination condition includes a number of training steps/epochs reaching pre-determined limit(s) and/or divergence (e.g., further training may cause over-fitting as diagnosable by increasing evaluation loss). Another example of a training termination condition includes a number of contiguous training epochs during which training loss is not decreasing more than a threshold amount (e.g., patience). Other examples of training termination conditions include early stopping criteria, reaching a maximum number of gradient updates, and/or the like.

In certain other aspects, loss calculation 324 may involve calculating loss values 326 for both the first and second iterations (e.g., where first mask prediction 320-1 and second mask prediction 320-2 are generated). Both loss values 326 may be used to modify various parameter(s) of ML model 318 during parameter modification 328, such as via back-propagation. It is noted that while FIG. 3 depicts an example where only two iterations are used for training, in some other examples, more iterations may be used, such as to improve the performance of ML model 318.

In certain aspects, a loss value 326, such as a classification loss, may be used for closed-set dataset training, in which only a fixed number of categories are included in the training data. However, in certain other aspects, such as for an open-vocabulary situation, there may exist an unlimited number of categories in training and test data; thus, the classification loss may not be used.

### Example AI System for Frame Segmentation

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example AI System for Object Detection

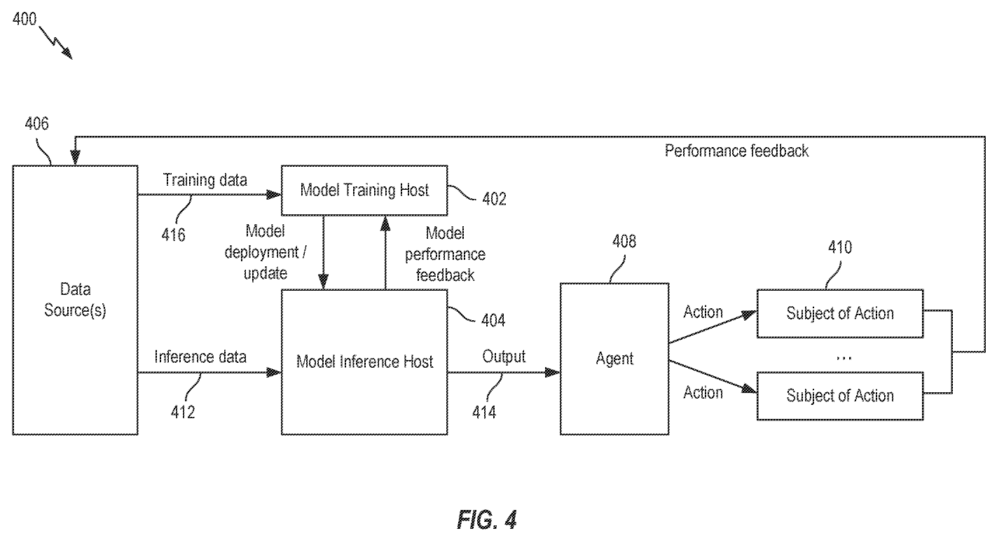

FIG. 4 is a diagram illustrating an example AI architecture 400 that may be used to implement the ML model(s) and frame segmentation techniques described in this disclosure. As illustrated, the architecture 400 includes multiple logical entities, such as a model training host 402 for training the ML model(s) for frame segmentation, a model inference host 404 for running inference using the trained ML Model(s) for frame segmentation and/or other downstream computer vision task(s), data source(s) 406 providing training and inference data, and an agent 408 that utilizes the model(s)' output. This AI architecture could be used to enable the disclosed frame segmentation techniques in various ML applications.

The model inference host 404, in the architecture 400, is configured to run the trained ML model(s) based on inference data 412 provided by data source(s) 406. The model inference host 404 may produce an output 414 (e.g., detected objects, scene representations) based on the inference data 412, which is then provided as input to the agent 408. The model inference host 404 utilizes the frame segmentation techniques described in this disclosure to generate accurate mask(s) for one or more target regions in a frame, thereby enabling downstream tasks such as object tracking and motion planning, among others.

The agent 408 may be an element or entity that utilizes the output of the ML model(s) hosted by the model inference host 404. The agent 408 could be a software component, a hardware accelerator, or a system that leverages the frame segmentation(s), and further mask(s), produced by the model(s) for various downstream tasks such as autonomous navigation, collision avoidance, or driver assistance systems.

For example, if the output 414 from the model inference host 404 includes masks for various objects in a scene, the agent 408 may be an object detection module and/or a motion planning module that generates safe and efficient trajectories for a robot. That is, in robotics, segmentation mask(s), such as output by the ML model(s) described herein, may be used to enable a robot to discern and navigate around objects in their environment.

After receiving the output 414 from the model inference host 404, the agent 408 may determine how to utilize it. For instance, if the agent 408 decides to use the output 414, it may apply it to the subject of the action 410, which represents the data being processed or enhanced. In some cases, the agent 408 and subject of action 410 may be tightly integrated.

The data sources 406 may be configured to collect data used as training data 416 for the model training host 402 to train the frame segmentation ML model(s). The data sources 406 may also provide inference data 412 to the model inference host 404. This data could come from various entities and may include the subject of action 410. For example, for training a frame segmentation model, the data sources 406 may collect synchronized sensor data from cameras, LiDAR, radar, and other sensors mounted on vehicles. The model training host 402 can then monitor the model(s)' performance on this data to determine if retraining or fine-tuning with the frame segmentation model is necessary to improve accuracy. In some cases, the agent 408 and the subject of action 410 are the same entity.

The data sources 406 may be configured for collecting data that is used as training data 416 for training the frame segmentation ML model(s). The data sources 406 may also provide inference data 412 (also referred to as input data) for feeding the trained model(s) during inference. In particular, the data sources 406 may collect data relevant to the frame segmentation task at hand, such as user input having different modalities, sensor data from various modalities, or the like. This data may come from various sources, including the subject of action 410, which represents the data being processed by the model(s). The collected data is provided to the model training host 402 for training and fine-tuning the object detection model. For example, after the subject of action 410 (e.g., sensor data with known object positions) is processed by the model(s), the output 414 (e.g., detected objects and scene representations) may be compared to ground truth data to evaluate the model(s)' performance. If the output 414 is not sufficiently accurate, this performance feedback may be used by the model training host 402 to further train the model using the disclosed object detection techniques, aiming to improve detection accuracy and robustness. The updated model(s) may then be deployed to the model inference host 404.

In certain aspects, the model training host 402 may be deployed at or with the same or a different entity than that in which the model inference host 404 is deployed. For example, to offload model training processing, which can impact the performance of the model inference host 404, the model training host 402 may be deployed at a model server as further described herein. Further, in some cases, training and/or inference may be distributed amongst devices in a decentralized or federated fashion.

In some aspects, the frame segmentation ML model(s) may be deployed at or on a computing device for enhancing the performance of downstream computer visions tasks, such as objection detection and related tasks. For example, a model inference host, such as model inference host 404 in FIG. 4, may be deployed at or on the computing device for running the frame segmentation ML model(s) to improve the detection accuracy and object tracking in dynamic environments.

In some other aspects, frame segmentation ML model(s) are deployed at or on an embedded system or mobile device for enabling efficient on-device inference. More specifically, a model inference host, such as model inference host 404 in FIG. 4, may be deployed at or on the embedded system or mobile device for running the model(s) to obtain the frame segmentations while meeting resource constraints.

### Example AI Model

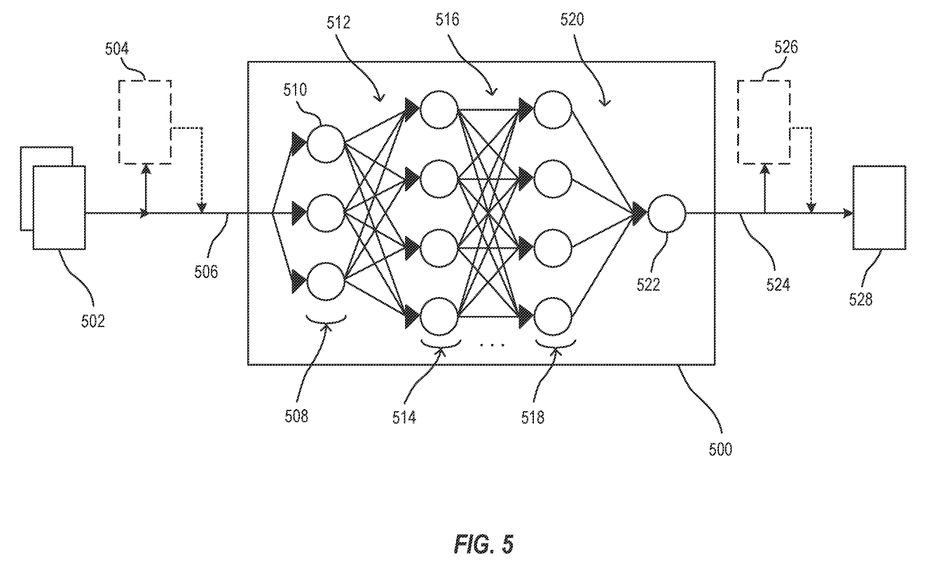

FIG. 5 is an illustrative block diagram of an example artificial neural network (ANN) 500 that can be used to implement the frame segmentation techniques described in this disclosure.

ANN 500 may receive input data 506, which may include one or more bits of data 502, pre-processed data output from pre-processor 504 (optional), or some combination thereof. Here, data 502 may include sensor data from various modalities (e.g., cameras, LiDAR, radar), such as one or more frames, user prompt(s), simulated prompt(s), or the like, e.g., depending on the stage of development and/or deployment of ANN 500. Pre-processor 504 may, for example, process all or a portion of data 502 to synchronize sensor inputs, apply calibration parameters, or normalize the data. In some implementations, pre-processor 504 may add additional data to data 502, such as time stamps or sensor metadata.

ANN 500 includes at least one first layer 508 of artificial neurons 510 (e.g., perceptrons) to process input data 506 and provide resulting first layer output data via edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. Post-processor 526 may be included within ANN 500 in some other implementations. Post-processor 526 may, for example, process all or a portion of output data 524 which may result in output data 528 being different, at least in part, to output data 524, e.g., as result of data being changed, replaced, deleted, etc. In some implementations, post-processor 526 may be configured to add additional data to output data 524, such as domain-specific post-processing or adaptation. In this example, second layer 514 and third layer 518 represent intermediate or hidden layers that may be arranged in a hierarchical or other like structure. Although not explicitly shown, there may be one or more further intermediate layers between the second layer 514 and the third layer 518.

The structure and training of artificial neurons 510 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to "activate" artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 412 in FIG. 4) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 500 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 500 may detect, determine, identify or ascertain patterns that are consistent across domains. Training data may represent various types of information, including written, visual, audio, environmental context, operational properties, etc., from different domains. During training, parameters of artificial neurons 510 may be changed, such as to minimize or otherwise reduce a loss function or a cost function that measures the model’s performance across domains. A training process may be repeated multiple times to fine-tune ANN 500 with each iteration to improve its domain generalization capability.

Various ANN model structures are available for consideration in the context of domain generalization and adaptation. For example, in a feedforward ANN structure each artificial neuron 510 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 500 or other ML models may be implemented in various types of processing circuits along with memory and applicable instructions therein, for example, as described herein with respect to FIG. 4. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Example Methods for Frame Segmentation

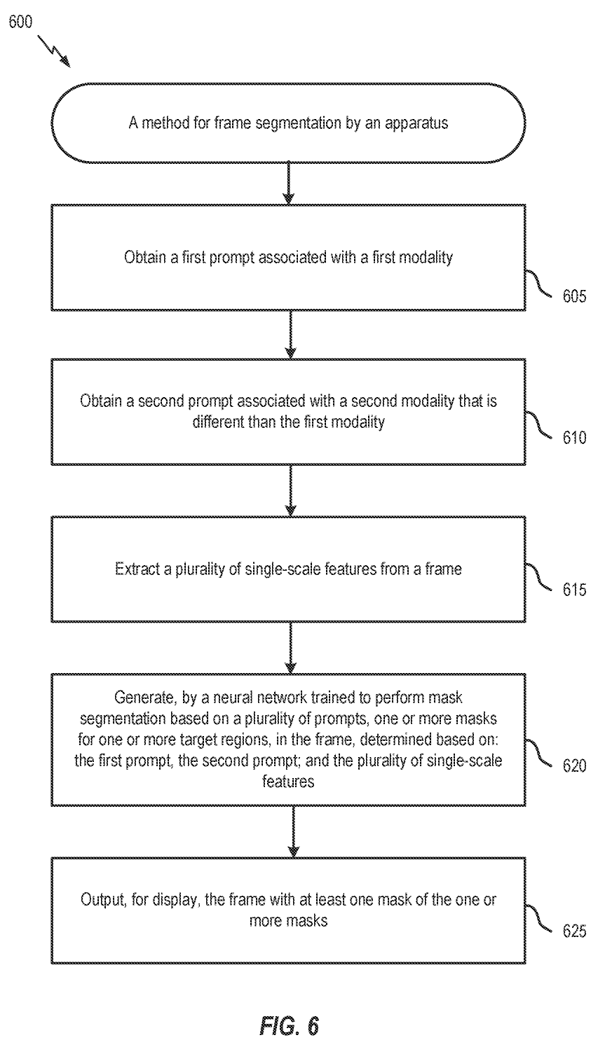

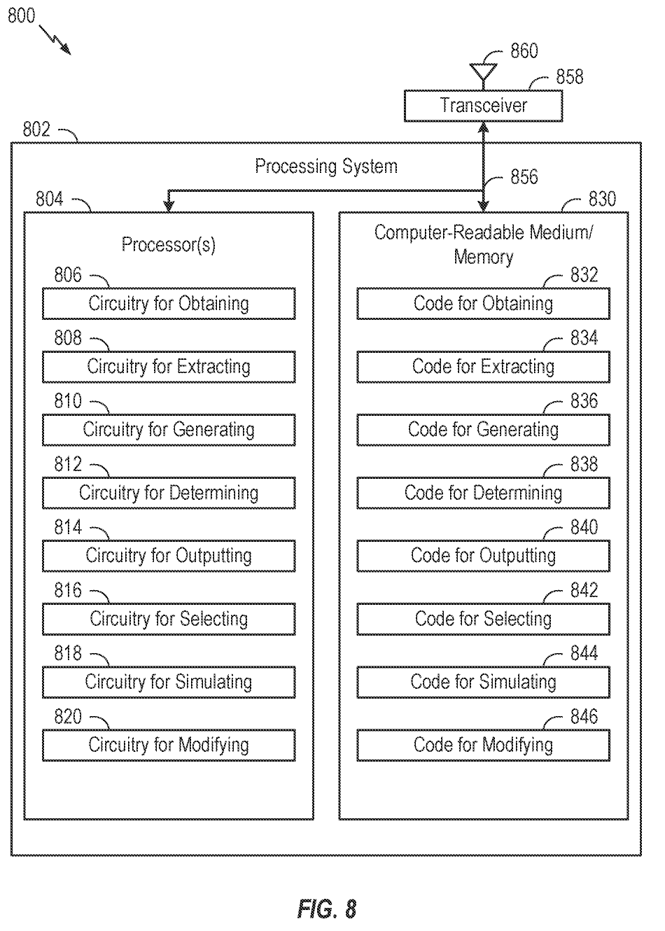

FIG. 6 depicts an example method 600 for frame segmentation. In certain aspects, method 600, or any aspect related to it, may be performed by an apparatus, such as apparatus 800 of FIG. 8, which includes various components operable, configured, or adapted to perform the method 600. Apparatus 800 is described below in further detail.

Method 600 begins at block 605 with obtaining a first prompt associated with a first modality.

Method 600 then proceeds to block 610 with obtaining a second prompt associated with a second modality that is different than the first modality.

Method 600 then proceeds to block 615 with extracting a plurality of single-scale features from a frame.

Method 600 then proceeds to block 620 with generating, by a neural network trained to perform mask segmentation based on a plurality of prompts, one or more masks for one or more target regions , in the frame, determined based on: the first prompt; the second prompt; and the plurality of single-scale features.

Method 600 then proceeds to block 625 with outputting, for display, the frame with at least one mask of the one or more masks.

In certain aspects, the apparatus is deployed on an edge device.

In certain aspects, the one or more masks comprise an instance segmentation mask and a semantic segmentation mask.

In certain aspects, the first prompt associated with the first modality comprises a textual input; and the second prompt associated with the second modality comprises a visual input.

In certain aspects, method 600 further includes generating, by a language model (LM) trained to convert textual data into text embeddings, a text embedding for the textual input, wherein the one or more target regions in the frame determined based on the first prompt comprise the one or more target regions in the frame determined based on the text embedding.

In certain aspects, the textual input comprises textual data that was not included in training data used to train the LM.

In certain aspects, method 600 further includes selecting a subset of the plurality of the single-scale features based on the visual input, wherein the one or more target regions in the frame determined based on the second prompt comprises the one or more target regions in the frame determined based on the subset of the plurality of the single-scale features.

In certain aspects, generating, by the neural network, the one or more masks, comprises generating, by the neural network, the one or more masks for the one or more target regions with a respective confidence score for each respective mask of the one or more masks; and outputting, for display, the frame with the at least one of the one or more masks, comprises outputting, for display, the frame with the at least one mask of the one or more masks having the respective confidence score above a threshold.

In certain aspects, the frame depicts one or more objects in a scene during a first time period; and the one or more target regions in the frame comprise at least one object of the one or more objects.

Note that FIG. 6 is just one example of a method, and other methods including fewer, additional, or alternative operations are possible consistent with this disclosure.

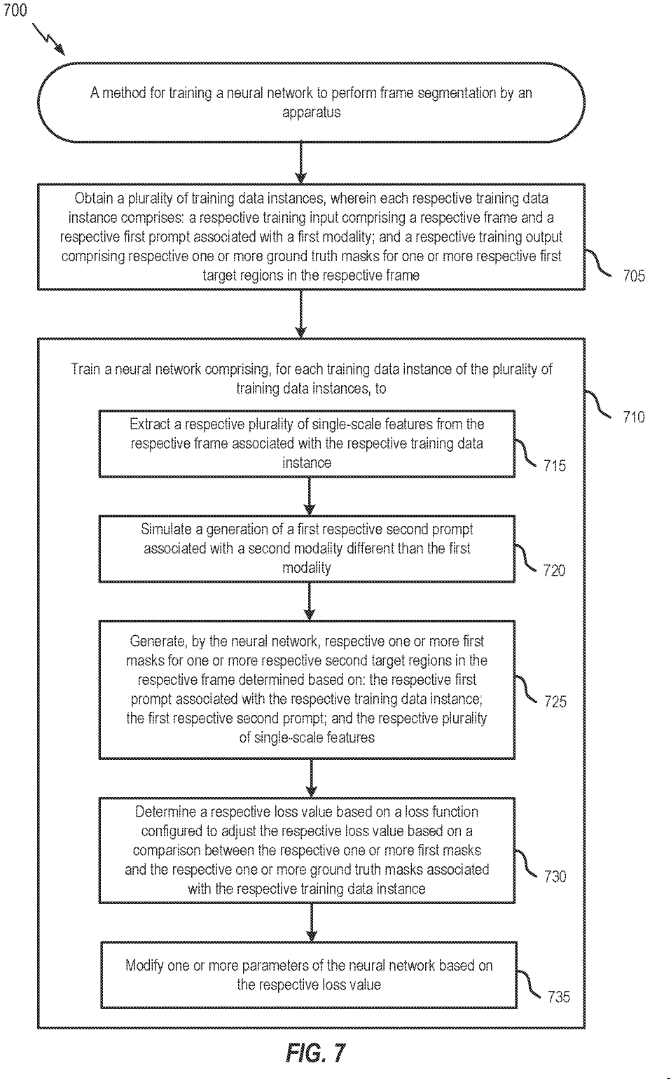

FIG. 7 depicts an example method 700 for training an ML model, such as a neural network, to perform frame segmentation. In certain aspects, method 700, or any aspect related to it, may be performed by an apparatus, such as apparatus 800 of FIG. 8, which includes various components operable, configured, or adapted to perform the method 700. As mentioned, apparatus 800 is described below in further detail.

Method 700 begins at block 705 with obtaining a plurality of training data instances. Each respective training data instance may include: a respective training input comprising a respective frame and a respective first prompt associated with a first modality; and a respective training output comprising respective one or more ground truth masks for one or more respective first target regions in the respective frame.

Method 700 then proceeds to block 710 with training the neural network (e.g., an ML model). Training the neural network may include performing steps at blocks 715-735 for each training data instance of the plurality of training data instances.

For example, method 700 proceeds to block 715 with extracting a respective plurality of single-scale features from the respective frame associated with the respective training data instance.

Method 700 then proceeds to block 720 with simulating a generation of a first respective second prompt associated with a second modality different than the first modality.

Method 700 then proceeds to block 725 with generating, by the neural network, respective one or more first masks for one or more respective second target regions in the respective frame determined based on: the respective first prompt associated with the respective training data instance; the first respective second prompt; and the respective plurality of single-scale features.

Method 700 then proceeds to block 730 with determining a respective loss value based on a loss function configured to adjust the respective loss value based on a comparison between the respective one or more first masks and the respective one or more ground truth masks associated with the respective training data instance.

Method 700 then proceeds to block 735 with modifying one or more parameters of the neural network based on the respective loss value.

In certain aspects, training the neural network comprises, for each training data instance: prior to determining the respective loss value: simulating a generation of a second respective second prompt associated with the second modality; and generating, by the neural network, respective one or more second masks for one or more respective third target regions in the respective frame determined based on: the respective first prompt associated with the respective training data instance; the second respective second prompt; and the respective plurality of single-scale features; and determining the respective loss value comprises determining the respective loss value based on the loss function being configured to adjust the respective loss value further based on a second comparison between the respective one or more second masks and the respective one or more ground truth masks associated with the respective training data instance.

In certain aspects, the respective one or more ground truth masks associated with the respective training data instance comprise at least one of an instance segmentation mask or a semantic segmentation mask.

In certain aspects, the respective first prompt associated with the first modality, associated with the respective training data instance, comprises a textual input; and the first respective second prompt associated with the second modality comprises a visual input.

In certain aspects, training the neural network comprises, for each training data instance: generating, by an LM trained to convert textual data into text embeddings, a text embedding for the textual input; and the one or more respective second target regions in the respective frame determined based on the respective first prompt comprise the one or more respective second target regions in the respective frame determined based on the text embedding.

In certain aspects, the textual input comprises textual data that was not included in training data used to train the LM.

In certain aspects, training the neural network comprises, for each training data instance: selecting a subset of the respective plurality of the single-scale features based on the visual input; and the one or more respective second target regions in the respective frame determined based on the first respective second prompt comprises the one or more respective second target regions in the respective frame determined based on the subset of the respective plurality of the single-scale features.

In certain aspects, the respective frame associated with the respective training data instance depicts one or more respective objects in a scene during a respective first time period; and the one or more respective first target regions in the respective frame comprise at least one object of the one or more respective objects.

Note that FIG. 7 is just one example of a method, and other methods including fewer, additional, or alternative operations are possible consistent with this disclosure.

### Example Apparatus for Frame Segmentation

FIG. 8 depicts aspects of an example apparatus 800. In certain aspects, apparatus 800 is a computing device, a mobile device, and/or an edge device.

The apparatus 800 includes a processing system 802, which may be coupled to a transceiver 858 (e.g., a transmitter and/or a receiver). The transceiver 858 is configured to transmit and receive signals for the apparatus 800 via an antenna 860, such as the various signals as described herein. The processing system 802 may be configured to perform processing functions for the apparatus 800, including processing signals received and/or to be transmitted by the apparatus 800.

The processing system 802 includes one or more processors 804. Generally, processor(s) 804 may be configured to execute computer-executable instructions (e.g., software code) to perform various functions, as described herein. The one or more processors 804 are coupled to a computer-readable medium/memory 830 via a bus 856. In certain aspects, the computer-readable medium/memory 830 is configured to store instructions (e.g., computer-executable code) that when executed by the one or more processors 804, enable and cause the one or more processors 804 to perform the method 600 described with respect to FIG. 6, or any aspect related to it, including any operations described in relation to FIG. 6; and/or the method 700 described with respect to FIG. 7, or any aspect related to it, including any operations described in relation to FIG. 7. Note that reference to a processor performing a function of the apparatus 800 may include one or more processors performing that function of the apparatus 800, such as in a distributed fashion.

In the depicted example, computer-readable medium/memory 830 stores code (e.g., executable instructions), including code for obtaining 832, code for extracting 834, code for generating 836, code for determining 838, code for outputting 840, code for selecting 842, code for simulating 844, and code for modifying 846. Processing of the code 832-846 may enable and cause the apparatus 800 to perform the method 600 described with respect to FIG. 6, or any aspect related to it; and/or the method 700 described with respect to FIG. 7, or any aspect related to it.

The one or more processors 804 include circuitry configured to implement (e.g., execute) the code stored in the computer-readable medium/memory 830, including circuitry for obtaining 806, circuitry for extracting 808, circuitry for generating 810, circuitry for determining 812, circuitry for outputting 814, circuitry for selecting 816, circuitry for simulating 818, and circuitry for modifying 820. Processing with circuitry 806-820 may enable and cause the apparatus 800 to perform the method 600 described with respect to FIG. 6, or any aspect related to it; and/or the method 700 described with respect to FIG. 7, or any aspect related to it.

More generally, means for communicating, transmitting, sending or outputting for transmission may include the transceiver 858 and/or antenna 860 of the apparatus 800 in FIG. 8, and/or one or more processors 804 of the apparatus 800 in FIG. 8. Means for communicating, receiving or obtaining may include the transceiver 858 and/or antenna 860 of the apparatus 800 in FIG. 8, and/or one or more processors 804 of the apparatus 800 in FIG. 8.

Apparatus 800 may be implemented in various ways. For example, apparatus 800 may be implemented within on-site, remote, or cloud-based processing equipment. As another example, apparatus 800 may be implemented on a mobile device, such as an edge device.

Apparatus 800 is just one example, and other configurations are possible. For example, in alternative aspects, aspects described with respect to apparatus 800 may be omitted, added, or substituted for alternative aspects.

### Example Clauses

Implementation examples are described in the following numbered clauses:

Clause 1: A method for frame segmentation by an apparatus, comprising: obtaining a first prompt associated with a first modality; obtaining a second prompt associated with a second modality that is different than the first modality; extracting a plurality of single-scale features from a frame; generating, by a neural network trained to perform mask segmentation based on a plurality of prompts, one or more masks for one or more target regions, in the frame, determined based on: the first prompt; the second prompt; and the plurality of single-scale features; and outputting, for display, the frame with at least one mask of the one or more masks.

Clause 2: The method of Clause 1, wherein the apparatus is deployed on an edge device.

Clause 3: The method of any one of Clauses 1-2, wherein the one or more masks comprise an instance segmentation mask and a semantic segmentation mask.

Clause 4: The method of any one of Clauses 1-3, wherein: the first prompt associated with the first modality comprises a textual input; and the second prompt associated with the second modality comprises a visual input.

Clause 5: The method of Clause 4, further comprising: generating, by a language model (LM) trained to convert textual data into text embeddings, a text embedding for the textual input, wherein the one or more target regions in the frame determined based on the first prompt comprise the one or more target regions in the frame determined based on the text embedding.

Clause 6: The method of Clause 5, wherein the textual input comprises textual data that was not included in training data used to train the LM.

Clause 7: The method of any one of Clauses 4-6, further comprising: selecting a subset of the plurality of the single-scale features based on the visual input, wherein the one or more target regions in the frame determined based on the second prompt comprises the one or more target regions in the frame determined based on the subset of the plurality of the single-scale features.

Clause 8: The method of any one of Clauses 1-7, wherein: generating, by the neural network, the one or more masks, comprises generating, by the neural network, the one or more masks for the one or more target regions with a respective confidence score for each respective mask of the one or more masks; and outputting, for display, the frame with the at least one of the one or more masks, comprises outputting, for display, the frame with the at least one mask of the one or more masks having the respective confidence score above a threshold.

Clause 9: The method of any one of Clauses 1-8, wherein: the frame depicts one or more objects in a scene during a first time period; and the one or more target regions in the frame comprise at least one object of the one or more objects.

Clause 10: A method, comprising: obtaining a plurality of training data instances, wherein each respective training data instance comprises: a respective training input comprising a respective frame and a respective first prompt associated with a first modality; and a respective training output comprising respective one or more ground truth masks for one or more respective first target regions in the respective frame; training a neural network comprising, for each training data instance of the plurality of training data instances: extracting a respective plurality of single-scale features from the respective frame associated with the respective training data instance; simulating a generation of a first respective second prompt associated with a second modality different than the first modality; generating, by the neural network, respective one or more first masks for one or more respective second target regions in the respective frame determined based on: the respective first prompt associated with the respective training data instance; the first respective second prompt; and the respective plurality of single-scale features; determining a respective loss value based on a loss function being configured to adjust the respective loss value based on a first comparison between the respective one or more first masks and the respective one or more ground truth masks associated with the respective training data instance; and modifying one or more parameters of the neural network based on the respective loss value.

Clause 11: The method of Clause 10, wherein: training the neural network comprises, for each training data instance: prior to determining the respective loss value: simulating a generation of a second respective second prompt associated with the second modality; and generating, by the neural network, respective one or more second masks for one or more respective third target regions in the respective frame determined based on: the respective first prompt associated with the respective training data instance; the second respective second prompt; and the respective plurality of single-scale features; and determining the respective loss value comprises determining the respective loss value based on the loss function being configured to adjust the respective loss value further based on a second comparison between the respective one or more second masks and the respective one or more ground truth masks associated with the respective training data instance.

Clause 12: The method of any one of Clauses 10-11, wherein the respective one or more ground truth masks associated with the respective training data instance comprise at least one of an instance segmentation mask or a semantic segmentation mask.

Clause 13: The method of any one of Clauses 10-12, wherein: the respective first prompt associated with the first modality, associated with the respective training data instance, comprises a textual input; and the first respective second prompt associated with the second modality comprises a visual input.

Clause 14: The method of Clause 13, wherein: training the neural network comprises, for each training data instance: generating, by a language model (LM) trained to convert textual data into text embeddings, a text embedding for the textual input; and the one or more respective second target regions in the respective frame determined based on the respective first prompt comprise the one or more respective second target regions in the respective frame determined based on the text embedding.

Clause 15: The method of Clause 14, wherein the textual input comprises textual data that was not included in training data used to train the LM.

Clause 16: The method of any one of Clauses 13-15, wherein: training the neural network comprises, for each training data instance: selecting a subset of the respective plurality of the single-scale features based on the visual input; and the one or more respective second target regions in the respective frame determined based on the first respective second prompt comprises the one or more respective second target regions in the respective frame determined based on the subset of the respective plurality of the single-scale features.

Clause 17: The method of any one of Clauses 10-16, wherein: the respective frame associated with the respective training data instance depicts one or more respective objects in a scene during a respective first time period; and the one or more respective first target regions in the respective frame comprise at least one object of the one or more respective objects.

Clause 18: One or more apparatuses, comprising: one or more memories comprising executable instructions; and one or more processors configured to execute the executable instructions and cause the one or more apparatuses to perform a method in accordance with any one of Clauses 1-17.

Clause 19: One or more apparatuses configured for object detection, comprising: one or more memories; and one or more processors, coupled to the one or more memories, configured to cause the one or more apparatuses to perform a method in accordance with any one of Clauses 1-17.

Clause 20: One or more apparatuses configured for object detection, comprising: one or more memories; and one or more processors, coupled to the one or more memories, configured to perform a method in accordance with any one of Clauses 1-17.

Clause 21: One or more apparatuses, comprising means for performing a method in accordance with any one of Clauses 1-17.

Clause 22: One or more non-transitory computer-readable media comprising executable instructions that, when executed by one or more processors of one or more apparatuses, cause the one or more apparatuses to perform a method in accordance with any one of Clauses 1-17.

Clause 23: One or more computer program products embodied on one or more computer-readable storage media comprising code for performing a method in accordance with any one of Clauses 1-17.

Clause 24: One or more apparatuses configured for object detection, comprising: a processing system that includes one or more processors and one or more memories coupled with the one or more processors, the processing system configured to cause the one or more apparatuses to perform a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
obtain a first prompt associated with a first modality;
obtain a second prompt associated with a second modality that is different than the first modality;
extract a plurality of single-scale features from a frame;
generate, by a neural network trained to perform mask segmentation based on a plurality of prompts, one or more masks for one or more target regions, in the frame, determined based on:
the first prompt;
the second prompt; and
the plurality of single-scale features; and
output, for display, the frame with at least one mask of the one or more masks.

2. The apparatus of claim 1, wherein the apparatus is deployed on an edge device.

3. The apparatus of claim 1, wherein the one or more masks comprise an instance segmentation mask and a semantic segmentation mask.

4. The apparatus of claim 1, wherein:
the first prompt associated with the first modality comprises a textual input; and
the second prompt associated with the second modality comprises a visual input.

5. The apparatus of claim 4, wherein:
the processing system is configured to cause the apparatus to generate, by a language model (LM) trained to convert textual data into text embeddings, a text embedding for the textual input; and
the one or more target regions in the frame determined based on the first prompt comprise the one or more target regions in the frame determined based on the text embedding.

6. The apparatus of claim 5, wherein the textual input comprises textual data that was not included in training data used to train the LM.

7. The apparatus of claim 4, wherein:
the processing system is configured to cause the apparatus to select a subset of the plurality of the single-scale features based on the visual input; and
the one or more target regions in the frame determined based on the second prompt comprises the one or more target regions in the frame determined based on the subset of the plurality of the single-scale features.

8. The apparatus of claim 1, wherein:
to cause the apparatus to generate, by the neural network, the one or more masks, the processing system is configured to cause the apparatus to generate, by the neural network, the one or more masks for the one or more target regions with a respective confidence score for each respective mask of the one or more masks; and
to cause the apparatus to output, for display, the frame with the at least one of the one or more masks, the processing system is configured to cause the apparatus to output, for display, the frame with the at least one mask of the one or more masks having the respective confidence score above a threshold.

9. The apparatus of claim 1, wherein:
the frame depicts one or more objects in a scene during a first time period; and
the one or more target regions in the frame comprise at least one object of the one or more objects.

10. A method for frame segmentation by an apparatus, comprising:
obtaining a first prompt associated with a first modality;
obtaining a second prompt associated with a second modality that is different than the first modality;
extracting a plurality of single-scale features from a frame;
generating, by a neural network trained to perform mask segmentation based on a plurality of prompts, one or more masks for one or more target regions, in the frame, determined based on:
the first prompt;
the second prompt; and
the plurality of single-scale features; and
outputting, for display, the frame with at least one mask of the one or more masks.

11. The method of claim 10, wherein the apparatus is deployed on an edge device.

12. The method of claim 10, wherein the one or more masks comprise an instance segmentation mask and a semantic segmentation mask.

13. The method of claim 10, wherein:
the first prompt associated with the first modality comprises a textual input; and
the second prompt associated with the second modality comprises a visual input.

14. The method of claim 13, further comprising:
generating, by a language model (LM) trained to convert textual data into text embeddings, a text embedding for the textual input, wherein the one or more target regions in the frame determined based on the first prompt comprise the one or more target regions in the frame determined based on the text embedding.

15. The method of claim 14, wherein the textual input comprises textual data that was not included in training data used to train the LM.

16. The method of claim 13, further comprising:
selecting a subset of the plurality of the single-scale features based on the visual input, wherein the one or more target regions in the frame determined based on the second prompt comprises the one or more target regions in the frame determined based on the subset of the plurality of the single-scale features.

17. The method of claim 10, wherein:
generating, by the neural network, the one or more masks, comprises generating, by the neural network, the one or more masks for the one or more target regions with a respective confidence score for each respective mask of the one or more masks; and
outputting, for display, the frame with the at least one of the one or more masks, comprises outputting, for display, the frame with the at least one mask of the one or more masks having the respective confidence score above a threshold.

18. The method of claim 10, wherein:
the frame depicts one or more objects in a scene during a first time period; and
the one or more target regions in the frame comprise at least one object of the one or more objects.

19. One or more non-transitory computer-readable media comprising executable instructions that, when executed by one or more processors of an apparatus, cause the apparatus to perform operations comprising:
obtaining a first prompt associated with a first modality;
obtaining a second prompt associated with a second modality that is different than the first modality;
extracting a plurality of single-scale features from a frame;
generating, by a neural network trained to perform mask segmentation based on a plurality of prompts, one or more masks for one or more target regions, in the frame, determined based on:
the first prompt;
the second prompt; and
the plurality of single-scale features; and
outputting, for display, the frame with at least one mask of the one or more masks.

20. The one or more non-transitory computer-readable media of claim 19, wherein the apparatus is deployed on an edge device.
